(19) United States
(12) Patent Application Publication
(10) Pub. No.: US 2016/0316181 A1
(43) Pub. Date: Oct. 27, 2016

(54) HEADPHONES WITH RETRACTABLE MONOCLE VIDEO SCREEN CONTROLLED BY REMOTE SMART DEVICE

(71) Applicant: RED STREET VENTURES, LLC, Austin, TX (US)

(72) Inventor: Andrew Hamra, Austin, TX (US)

(73) Assignee: RED STREET VENTURES, LLC

(21) Appl. No.: 15/135,170

(22) Filed: Apr. 21, 2016

Related U.S. Application Data
(60) Provisional application No. 62/151,132, filed on Apr. 22, 2015.

(51) Int. Cl. H04N 9/31; G02B 27/01; H04N 5/225; H04N 7/18; H04R 1/10; H04R 1/08

(52) U.S. Cl. CPC H04N 9/31; H04R 1/1008; H04R 1/08; H04N 5/2251; H04N 7/185; G02B 27/0176; G02B 27/0172; G02B 2027/0156; H04R 2201/107; G02B 2027/0138; H04B 1/385

(57) ABSTRACT

This type of headphone with retractable monocle video screen is able to pull down the retractable monocle video screen when it is needed and retract it when it is not. The screen display is controlled via a remote smart device. The viewing screen of the retractable video screen is simply a projection of the user's smartphone, smart watch, or tablet screen and is connected via a Bluetooth connection created between the headphone device and the satellite device. Thus, the satellite devices act as a remote control and there is no need for a computing system to be built into the headphones.

### CROSS-REFERENCE TO RELATED APPLICATIONS

This application claims the benefit of U.S. Provisional Application No. 62/151,132, filed Apr. 22, 2015.

### FIELD OF THE INVENTION

The present disclosure generally relates to headphones that include a retractable video screen that is affixed to one side and that maneuvers to a position over one eye. The screen display is controlled via a remote smart device.

### DESCRIPTION OF RELATED ART

Current wearable devices such as Google Glass and others have been less successful in the marketplace because the viewing screen was too small and there was no indication whether the camera was in the on/off position.

The existing technology relies upon interface and operability components to be included within the wearable device which is burdensome and not cost effective.

### SUMMARY OF THE INVENTION

The present disclosure and device addresses both of these concerns by using headphones (instead of glasses) as the basic core device and by allowing the user to entirely control what is displayed on the screen by interacting with the smartphone. By using this type of device and structure, the user is able to pull down the screen when it is needed and retract it when it is not.

Furthermore, the viewing screen of the retractable video screen is simply a projection (i.e. such a display unit may be anything from a device which projects the image onto a lens of the glass to a display screen disposed where it may be seen, either on the lens or otherwise) of the user's smartphone, smart watch, or tablet screen and is connected via a Bluetooth connection created between the headphone device and the satellite device. Thus, the satellite devices act as a remote control and there is not a need for a computing system to be built into the headphones.

The main component of the device is a set of headphones that covers each ear and has an arching connector (stem) over the top of the head for support. The material can be made of any metal, plastic or solid matter that creates a solid form. Each earpiece can be made adjustable to provide for a better fit and the stem itself may have adjustable components so that it can be fitted to different size heads, and different size ears and/or adjusted and folded for storing purposes. When in the stowaway position and is needed for viewing, it can be pulled down over the eye. The video screen arm and the retractable video screen are both adjustable as well to provide for correct fit with the particular user.

The retractable video screen is preferably the size of a user's eye region, allowing for a sizable viewing area which covers only one eye. The retractable video screen is made of a transparent plastic or similar component through which a small projector displays the image of the content that is being displayed on the home screen of the satellite device. The video screen arm, which connects the screen to the headphones, contains within the projector for the display, a rechargeable battery, and Bluetooth connection module and device. When the power source for the projector for the display, the Bluetooth module and device or the headphones needs to be recharged, the entire device can be plugged into a power source via a jack that may be positioned anywhere on the headset or arm.

Another aspect of the present disclosure is the display being composed of a transparent material so that the remote devices screen displays on a prism inside the monocle screen attached to the headset. This allows the projection to be visible from the user's eye as clear and undistorted image. The projection is controlled remotely by the smartphone.

According to another aspect of the present disclosure, the retractable video screen can be either one of a curved or flat surface depending on the type of prism used to project the image onto display screen.

The video screen arm may be constructed of a bendable or malleable material in order for it to be shaped to fit different size head shapes. At the point where the video screen arm connects to the headphones is a pivot point that is securely fastened. Where the video screen arm meets the video screen, there is an additional pivot point which may also include a sliding device for proper adjustments depending on the user's fitting of the device.

The retractable video screen arm may include a microphone so that the headset can also act as a voice controlled remote for the satellite device. The user can speak into the microphone attached to the headset and the microphone will allow the user to control their remote device through verbal commands. Any commands that change the screen of the satellite device will project onto the retractable video screen of the headset.

According to another aspect of the present disclosure, the video screen arm contains a camera that operates independently from the projector. The camera functions when retractable arm is down position over the user's eye.

The operation of the camera in the video screen arm is controlled by a satellite device just as it would be seen on the screen of the satellite device. All of the functionality is enabled, meaning that tapping the screen or particular button of satellite device that initiates capturing image has same effect for the lens on video screen arm of headset.

The headphones continue to function as standard headphones receiving audio from remote device in conjunction with or separate to home display screen on a satellite device. Users can listen to specific music while viewing social media or news. The basic core device headphones may be noise cancelling and one of the earphones can be removed from headset so user can still use video screen and have one ear available to hear the surrounding noises to remain aware of the outside environment.

Another aspect of the present disclosure is that the headset may use a direct wire to connect to a satellite device. The direct wire may connect through a headphone jack or alternatively through an input jack depending on needs of video or audio sharing.

The recharging input on the headphone will be independent of the remote device input in order for it to be charged while in use by the user. A recharging input may be on the earphone casing, the stem, or the video screen arm depending on best functionality and placement of the recharging input.

In another aspect of the present disclosure, different fabrics or material may be used to cover the solid material of the headset and/or the retractable video screen arm. Leather or an alternate textile can enhance the design aesthetic and comfort of headset.

One aspect of earphone component of headphones is that the cushion may cover the whole ear resting on the skull around ear or make use of smaller area resting on the ear itself.

### BRIEF DESCRIPTION OF THE DRAWINGS

These and other objects and features of the present invention will become clearer from the following description of the preferred embodiments given with reference to the attached drawings.

FIG. 1 is the front right side angle view of the headphones device with the retractable viewing screen in the down or “viewing” position. The retractable video screen arm of the viewing screen is attached to the outside casing of the right earphone which is connected to the left earphone via the overhead arching stem.

FIG. 2 is the front left list angle of the headphones with the retractable video screen in the upright or “stowed” position. The viewing screen and arm align the arching stem at the top of the head.

FIG. 3 is a front image of a user wearing the headset with viewing screen in “viewing” position. The headset is connected to “source” satellite device (i.e. a smartphone). The satellite device acts as a remote control for the headset screen: the content that is visible on the satellite device screen is projected onto retractable viewing screen of headset.

### DETAILED DESCRIPTION OF THE PREFERRED EMBODIMENTS

Described are one or more embodiments of headphones with a retractable monocle projection screen displaying home screen of remote satellite device (i.e. smartphone or smart watch) connected by cable or Bluetooth module.

According to one aspect of the headset with the retractable video screen, the projector is turned on automatically when arm is pulled down by the user from the upright stowed position to the viewing position. Similarly, when the arm is retracted back up to stowed position from the viewing position over stem the video screen is automatically turned off. However, the earphones will remain on regardless of position of retractable display screen to ensure audio is consistently available.

According to another aspect of headset with the retractable screen, when the retractable video screen arm is pulled down into the viewing position, the connection to the remote device is activated via Bluetooth or directly though the wired connectivity.

In one embodiment, when the retractable video screen is in the viewing position the camera may be activated by pressing the photo and/or video button on the connected satellite device.

The advantage of a retractable video screen over one eye allows the user to stay engaged with their environment and surroundings without having to continually look down at their smart device for viewing and updates.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

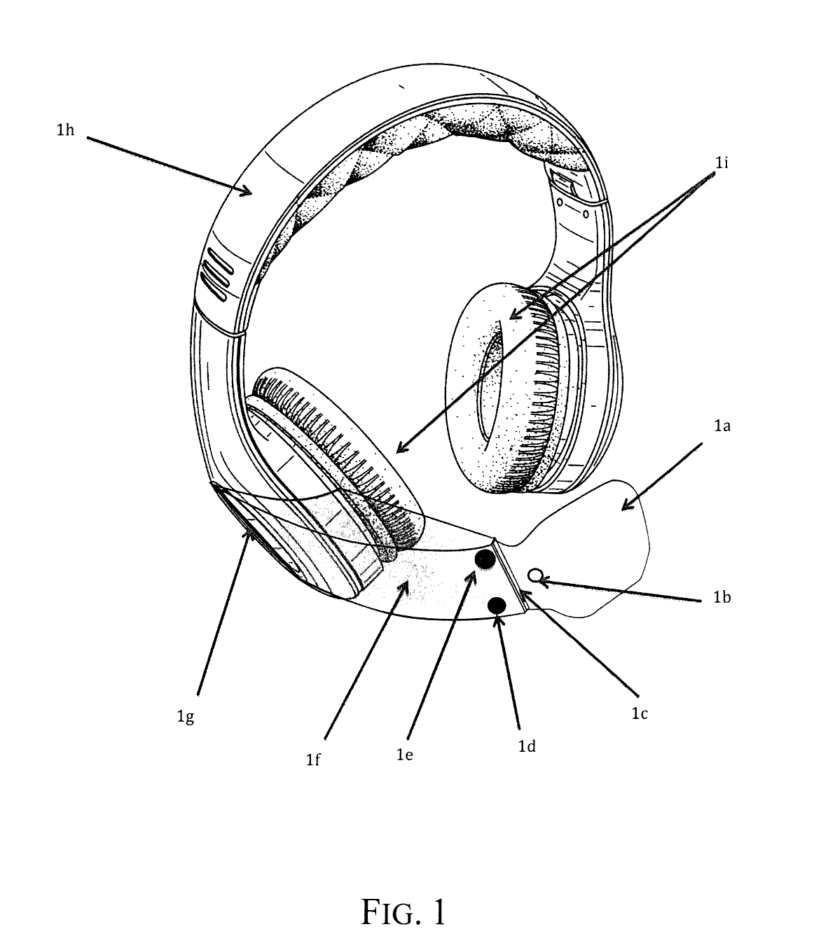

FIG. 1 shows the headset with the flat monocle display screen 1a in the down, viewing position where the flat monocle screen 1a is in front of one eye of user.

A flat monocle display screen 1a is connected to the retractable video screen arm 1f. The eye 1b of the projector projects through the prism displaying the image on the flat monocle screen 1a. The pivot point 1c where the display screen connects to retractable video screen arm 1f, allows for an adjustable viewing experience. The microphone 1d also communicates with satellite source device (i.e. headphone wires).

The camera lens 1e operates independently of the projector. The retractable video screen arm 1f connects the flat monocle display screen 1a to the headphones. The retractable video screen arm 1f houses the components for the projector, microphone, camera, Bluetooth module and device as well as the rechargeable battery.

The pivot point 1g is where the retractable video screen arm 1f connects to the headphones. In the down, viewing position, the retractable video screen arm 1f and the flat monocle display screen 1a are at eye level and whether in a viewing or stowed position, it is above the head in line with the stem 1h of the headphones.

The stem of headphones 1h connects both earphones over the top of the head or skull. The earphones 1i contain a cushion allowing them to go over the ears.

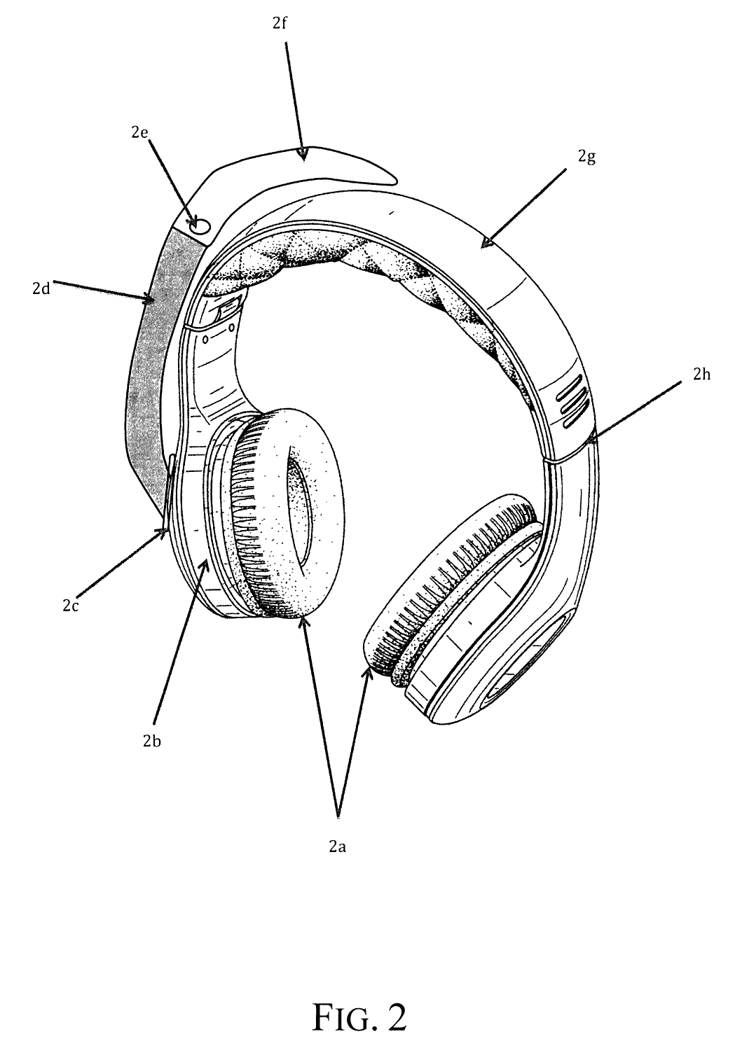

FIG. 2 shows the headset when the retractable video screen arm 2d in the upright, stowed position. The earphones 2a of the headset are padded. The casing of the headphones 2b can be made of plastic, metal or other material depending on the style of headphone.

The rotating connector 2c allows the retractable video screen arm 2d to attach to the headphones and rotate between viewing and stowed positions.

The retractable video screen arm 2d is in upright position in line with stem of headphones 2g. The eye of the projector 2e is in the upright position. The display screen 2f is in stowed position above the headphone stem 2g. The headphone stem 2g connects the left earphone to the right earphone. The point where the earphones can be adjusted to fit different size heads, as well as the point where one earphone can be removed allowing the user to have one ear to hear their environment.

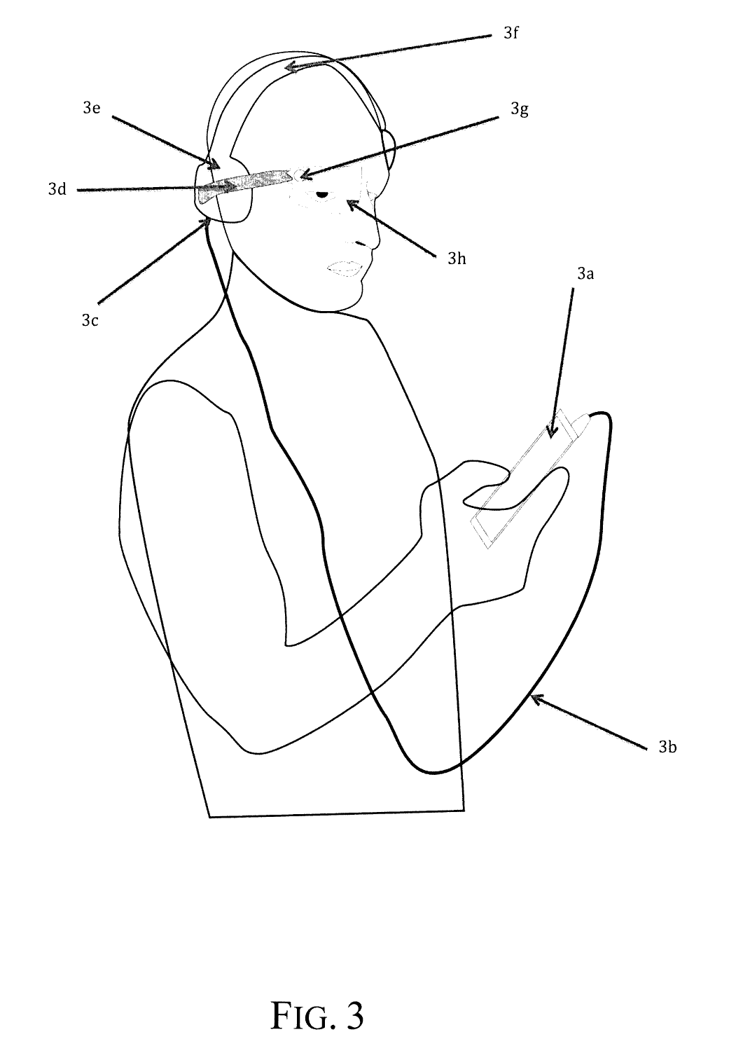

FIG. 3 is a drawing showing the headset in use with the satellite device 3a. The connecting cord 3b is the component that connects the satellite device 3a to a headset. It has been previously noted that connection between satellite device 3a and headset may be wireless in which case Bluetooth or another form of connectivity would be used.

The insert jack 3c is where a cord connects the satellite device 3a to the headset. The charging jack is independent of the connection jack. The retractable video screen arm 3d is in the down or viewing position. The earphone component 3e of headset and the stem 3f runs over top of head and connects both earphones. The eye 3g of the projector projects through the prism onto the display screen. The display screen 3h is in down, viewing position in front of the user's eye.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A wearable headset comprising:
a first and second earphone extending from the wearable headset,
a retractable monocle lens configured to be rotatably connected to the wearable headset, and
a screen of a remote device configured to be displayed on the retractable monocle lens, wherein
the remote device is configured to operate as a touch sensitive remote controller for the retractable monocle lens.

2. The wearable headset according to claim 1, wherein
the retractable monocle lens is configured to be turned on when positioned in a viewing position, and
the retractable monocle lens is configured to be turned off when positioned in a stowed position.

3. The wearable headset according to claim 1, wherein
the retractable monocle lens includes a monocle display screen and a retractable video screen arm, and
the monocle display screen is configured to be flat or curved.

4. The wearable headset according to claim 3, further comprising:
an eye of a projector positioned on the monocle display screen and configured to project through a prism onto the monocle display screen.

5. The wearable headset according to claim 3, further comprising:
a microphone configured to be positioned on the retractable video screen arm.

6. The wearable headset according to claim 3, further comprising:
a camera configured to be positioned on the retractable video screen arm.

7. The wearable headset according to claim 3, wherein
the monocle display screen is configured to be composed of a transparent material.

8. The wearable headset according to claim 3, further comprising:
a first pivot point between the retractable video screen arm and the monocle display screen, and
a second pivot point between a first earphone and the retractable video screen arm.

9. A method for displaying a home screen on a retractable monocle lens, the method comprising:
extending a first and second earphone from the wearable headset,
rotatably connecting a retractable monocle lens to the wearable headset, and
displaying a screen of a remote device on the retractable monocle lens, wherein
the remote device is configured to operate as a touch sensitive remote controller for the retractable monocle lens.

10. The method according to claim 9, wherein
the retractable monocle lens is configured to be turned on when positioned in a viewing position, and
the retractable monocle lens is configured to be turned off when positioned in a stowed position.

11. The method according to claim 9, wherein
the retractable monocle lens includes a monocle display screen and a retractable video screen arm, and
the monocle display screen is configured to be flat or curved.

12. The method according to claim 11, further comprising:
positioning on the monocle display screen an eye of a projector configured to project through a prism onto the monocle display screen.

13. The method according to claim 11, further comprising:
a microphone configured to be positioned on the retractable video screen arm.

14. The method according to claim 11, further comprising:
positioning a camera on the retractable video screen arm.

15. The method according to claim 11, wherein
the monocle display screen is configured to be composed of a transparent material.

16. The method according to claim 11, further comprising:
positioning a first pivot point between the retractable video screen arm and the monocle display screen, and
positioning a second pivot point between a first earphone and the retractable video screen arm.
